(19) United States
(12) Patent Application Publication
(10) Pub. No.: US 2002/0198930 A1
(43) Pub. Date: Dec. 26, 2002

(54) Method and apparatus for wide-spread distribution of electronic content in a peer to peer fashion

(75) Inventors: Jeffrey Allen Jones, Round Rock, TX (US); Douglas Scott Rothert, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/888,473

(22) Filed: Jun. 25, 2001

(51) Int. Cl. G06F 15/16

(52) U.S. Cl. 709/201; 714/4

(57) ABSTRACT

A method, program and system for distributing information in a computer network are provided. The invention comprises dividing an electronic file into a plurality of pieces and then downloading a file piece to the first client machine to request that file piece. If a second client machine requests the same file piece, the request is redirected to the first client. The first client then functions as a peer-to-peer server and downloads the requested file piece to the second client.

### CROSS REFERENCE TO RELATED APPLICATIONS

The present application is related to co-pending U.S. patent application Ser. No. ______ (IBM Docket No. AUS920010403US1) entitled “Method and Apparatus to Encourage Client into a Distributed Peer to Peer Sharing Technology” filed even date herewith. The content of the above mentioned commonly assigned, co-pending U.S. Patent applications are hereby incorporated herein by reference for all purposes.

### BACKGROUND OF THE INVENTION

1. Technical Field

The present invention relates generally to computer network environments, and more specifically to the mass distribution of data.

2. Description of Related Art

Current technology for mass distribution of data over the Internet consists of one or more “master” servers where the content is available, and many more “mirror” sites where the same data is stored. Typically, the master server is overwhelmed very easily, and end users are forced to manually attempt a list of mirror sites. Each of those mirror sites may or may not actually have the updated content because they are typically driven by time-based automation (typically a cron job scheduled at midnight). This distribution scheme is incredibly problematic and wasteful in dealing with the initial wave of interest in specific data.

Therefore, it would be desirable to have a method for seemless peer-to-peer offloading of demands on master servers to other nearby clients which are downloading the same content.

### SUMMARY OF THE INVENTION

The present invention provides a method, program and system for distributing information in a computer network. The invention comprises dividing an electronic file into a plurality of pieces and then downloading a file piece to the first client machine to request that file piece. If a second client machine requests the same file piece, the request is redirected to the first client. The first client then functions as a peer-to-peer server and downloads the requested file piece to the second client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating peer-to-peer offloading in accordance with the present invention;

FIG. 5 depicts a flowchart illustrating the circumvention of a down peer-to-peer server in accordance with the present invention; and

FIG. 6 depicts a flowchart illustrating security procedures in peer-to-peer data distribution in accordance with the present invention.

### DETAILED DESCRIPTION OF THE PREFERRED EMBODIMENT

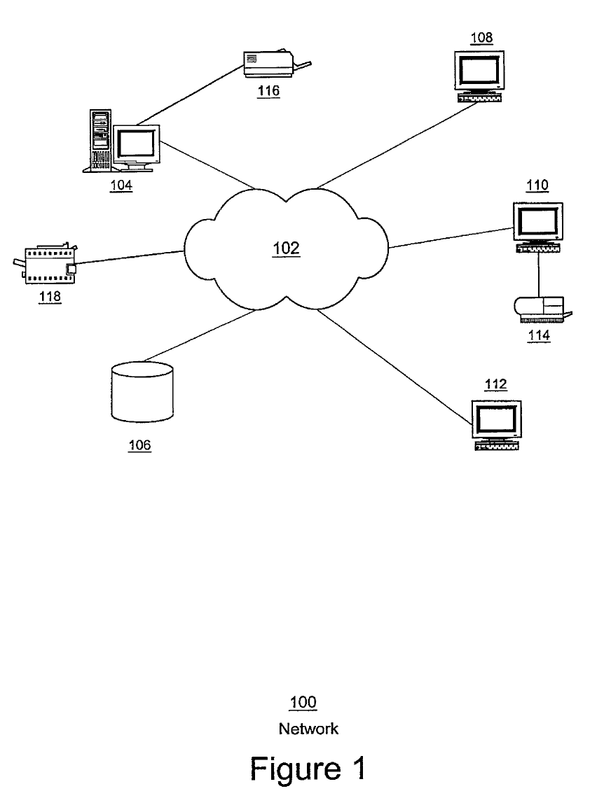

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

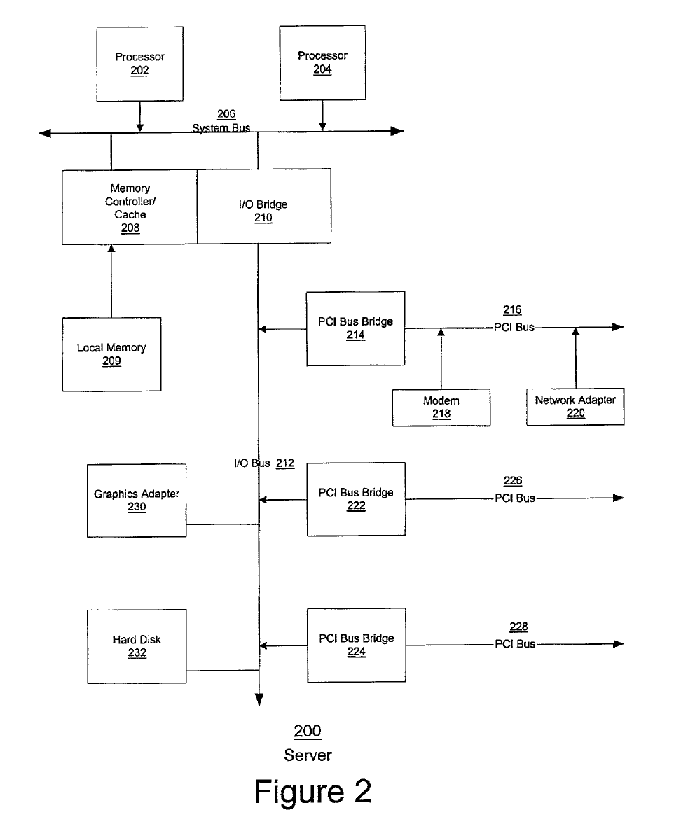

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

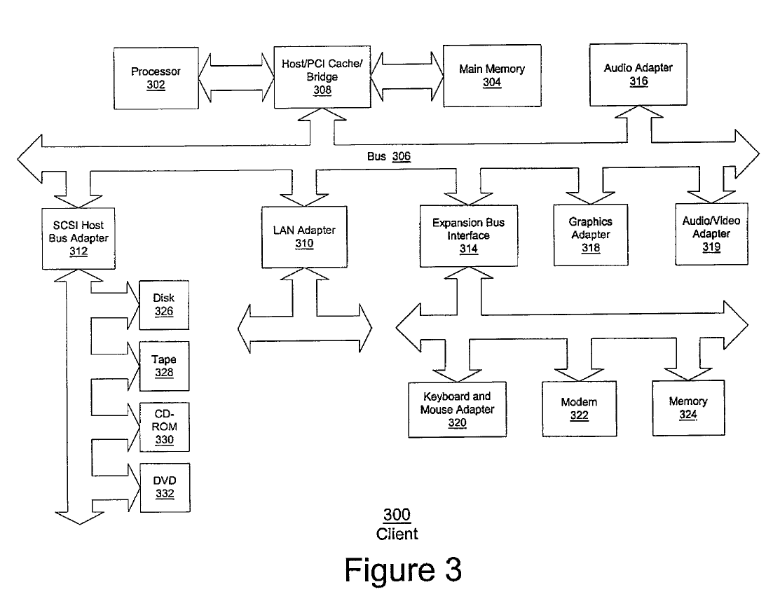

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

In prior art approaches for the mass distribution of data, a direct connection is opened from a client to a server (either the master server or a mirror site). All bytes of the requested file are then downloaded in order, from first to last. In some cases, if the connection is broken the client may re-start the download at the point of error. In all cases the download is linear and sequential, and either byte or packet based. Typically, the server addresses a finite number of requests, until it is saturated by bandwidth limits.

The present invention provides a method for employing the seemless use of peer-to-peer technology to offload demands on master servers to other nearby clients which are downloading the same content.

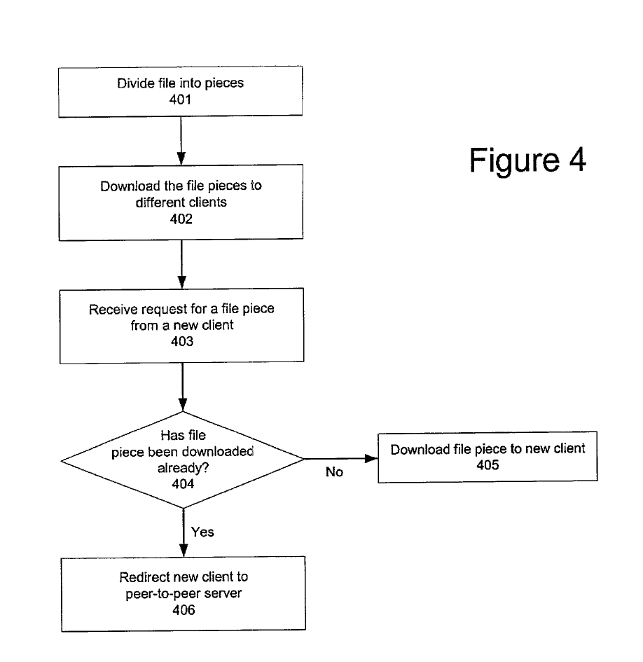

Referring now to FIG. 4, a flowchart illustrating peer-to-peer offloading is depicted in accordance with the present invention. This process modifies the prior art approach in order to reduce bandwidth consumption across the Internet as a whole. The process begins by breaking a large file into pieces (step 401). For example, if the file is 650 megabytes (MB), the file might be broken into 650 1-MB pieces. These pieces are then downloaded to different clients (step 402). In the present example, each client would then have exactly 1/650th of the total file and could rebroadcast its respective 1-MB piece to a peer client.

When a new client requests a piece of the file (step 403), the server containing the original complete file determines if the file piece requested by the client has already been downloaded to another client (step 404). If the requested file piece has not been downloaded, the server fulfills the request and downloads the requested file piece to the new client (step 405). If the requested file piece has already been downloaded to another client, the server redirects the new requesting client to a peer-to-peer server (step 406). This redirection could be based on relative network location. For example, all requests for a file piece in Texas would go to a peer-to-peer server in Texas.

The effect of employing the present invention is that as the number of people attempting to access the file increases, the list of peer-to-peer servers mirroring the file (and the potential bandwidth added by those servers) also increases at the same or potentially faster rate. The size and number of pieces into which a file is divided can be dynamically altered based on load. In this way, the greater the load, the smaller the pieces given from the master server and the greater the dependency on peer-to-peer servers.

The following example helps further illustrate the application of the present invention. 650 clients attempt to download the same 650-MB file at the same time from the same master server and wait in queue to be serviced. The first 65 machines connect to the master server and receive a piece of the file and share it with at least ten other client machines. In this way, the master server only has to deal with 65 downloads (assuming none of the peer-to-peer servers share data, otherwise the number will be less), plus the overhead of redirecting the other clients to the right machines. The cost of redirecting the clients (in CPU use and bandwidth) is less than the cost of retransmitting the same file 650 times.

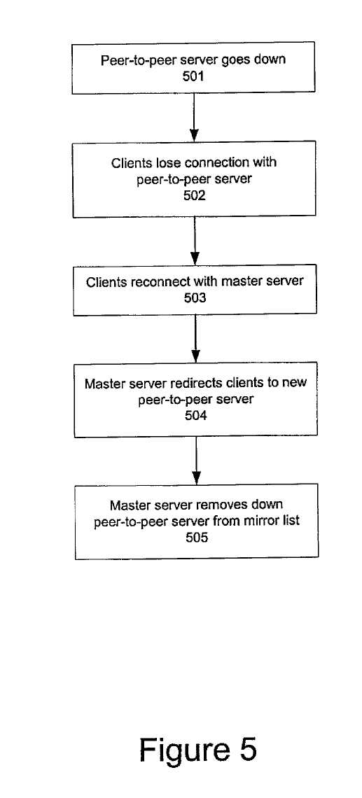

Referring to FIG. 5, a flowchart illustrating the circumvention of a down peer-to-peer server is depicted in accordance with the present invention. Using the above example, there is the potential that any of the 65 peer-to-peer servers could go down at any time (after all, they are owned by the end users) (step 501). As a result, clients will lose their connection to the peer-to-peer server (step 502) and have to reconnect to the master server (step 503). The master server will then redirect the clients to another peer-to-peer server, or turn the clients into peer-to-peer servers themselves (step 504). The master server then removes the down peer-to-peer server from the list of peer-to-peer mirrors (step 505).

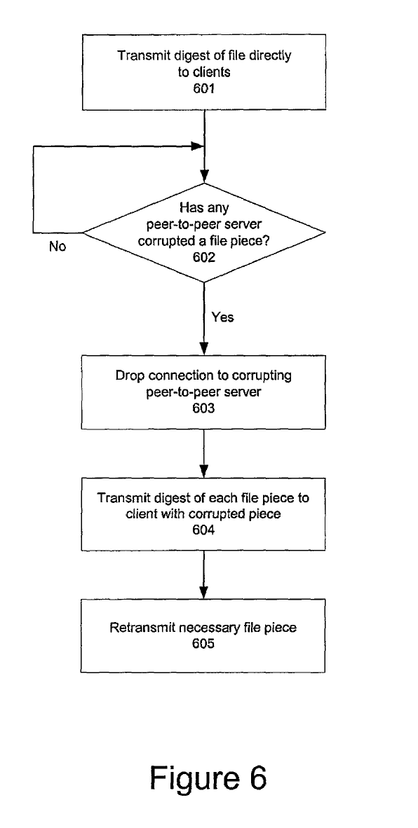

Referring now to FIG. 6, a flowchart illustrating security procedures in peer-to-peer data distribution is depicted in accordance with the present invention. For security reasons, the master server may transmit a small digest for the file directly to the clients (step 601). This is done so that the clients can accurately tell if any of the peer-to-peer servers have corrupted their respective file pieces (step 602). A digest is typically a set of verification bytes, such as Cyclic Redundancy Checking (CRC), that are unique to a block of data. As a simplified example, a chunk of data such as “this is my happy string” might have a CRC value of 14. It is a one-way algorithm that works almost uniquely to verify that the data is intact. Continuing the above example, a server/peer might send the CRC first, then “this is my happy string”, and the client would compare the CRC for the string and verify that it was transmitted successfully.

In the case of sending an entire file at once, the server/peer only needs to send a single digest for the whole file, because the granularity is on a fine basis. The client either does or does not receive the whole file. In the case of transmitting pieces of a file, a separate digest must be sent to verify each piece (as opposed to a single digest for the whole file). In addition, verifying each file piece is more effective for large files, because the higher the ratio of data to digest (i.e. one digest for the whole file), the less likely one is to get a unique number, and the larger the possibility of undetected problems.

If one of the peers decides to pass on unwanted data (e.g. a computer virus), the digest of the data will not match the digest from the master server, and the client will know to throw away the bogus data. If a file piece has been corrupted, the receiving client will contact the master server the master server, which will then drop the connection to the corrupting peer-to-peer server (step 603). In addition, digests for each file piece could be sent from the master server to the client so that the client can determine which piece of the file needs to be retransmitted (step 604). The master server can then retransmit the necessary file piece (step 605). It is also suggested that detailed information about the server be sent in the digest of the entire file. In this way, it would be possible to immediately determine the origin of the illegally distributed materials, regardless of how many peer-to-peer servers are involved in the transfer.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for distributing information in a computer network, the method comprising:
dividing an electronic file into a plurality of pieces;
receiving a request for a file piece from a first client machine;
downloading the requested file piece to the first client machine;
receiving a request for said file piece from a second client machine; and
redirecting the request of the second client machine to the first client machine.

2. The method according to claim 1, further comprising:
downloading all file pieces to a plurality of client machines, wherein the client machines function as peer-to-peer servers for other client machines requesting said file pieces.

3. The method according to claim 2, wherein each peer-to-peer server stores a unique file piece.

4. The method according to claim 2, further comprising:
receiving a request for a file piece stored in a first peer-to-peer server which is no longer connected to the computer network;
redirecting said request to a second peer-to-peer server containing a copy of said file piece; and
removing the first peer-to-peer server from a list of available peer-to-peer servers.

5. The method according to claim 2, further comprising:
sending a digest for a file piece to each client machine which has received that file piece.

6. The method according to claim 5, further comprising:
receiving a message from a client, wherein the message indicates that a peer-to-peer server has corrupted a file piece;
disconnecting the peer-to-peer server responsible for corrupting said file piece; and
retransmitting said file piece to said client, wherein the retransmitted file piece is free of any corrupting content.

7. A method for distributing information in a computer network, the method comprising:
requesting one of a plurality of pieces of an electronic file, wherein the electronic file is stored in a server;
receiving the requested file piece from the server;
receiving a request for said file piece from a client machine, wherein the request is redirected from the server; and
sending said file piece to said client machine.

8. A method for obtaining distributed information in a computer network, the method comprising:
requesting one of a plurality of pieces of an electronic file, wherein the electronic file is stored in a server;
receiving the requested file piece from a client machine containing a copy of said file piece.

9. A computer program product in a computer readable medium for use in a data processing system, for distributing information in a computer network, the computer program product comprising:
instructions for dividing an electronic file into a plurality of pieces;
instructions for receiving a request for a file piece from a first client machine;
instructions for downloading the requested file piece to the first client machine;
instructions for receiving a request for said file piece from a second client machine; and
instructions for redirecting the request of the second client machine to the first client machine.

10. The computer program product according to claim 9, further comprising:
instructions for downloading all file pieces to a plurality of client machines, wherein the client machines function as peer-to-peer servers for other client machines requesting said file pieces.

11. The computer program product according to claim 10, wherein each peer-to-peer server stores a unique file piece.

12. The computer program product according to claim 10, further comprising:
instructions for receiving a request for a file piece stored in a first peer-to-peer server which is no longer connected to the computer network;
instructions for redirecting said request to a second peer-to-peer server containing a copy of said file piece; and
instructions for removing the first peer-to-peer server from a list of available peer-to-peer servers.

13. The computer program product according to claim 10, further comprising:
instructions for sending a digest for a file piece to each client machine which has received that file piece.

14. The computer program product according to claim 13, further comprising:
instructions for receiving a message from a client, wherein the message indicates that a peer-to-peer server has corrupted a file piece;
instructions for disconnecting the peer-to-peer server responsible for corrupting said file piece; and
instructions for retransmitting said file piece to said client, wherein the retransmitted file piece is free of any corrupting content.

15. A computer program product for distributing information in a computer network, the method comprising:
instructions for requesting one of a plurality of pieces of an electronic file, wherein the electronic file is stored in a server;
instructions for receiving the requested file piece from the server;
instructions for receiving a request for said file piece from a client machine, wherein the request is redirected from the server; and
instructions for sending said file piece to said client machine.

16. A computer program product for obtaining distributed information in a computer network, the method comprising:
instructions for requesting one of a plurality of pieces of an electronic file, wherein the electronic file is stored in a server;
instructions for receiving the requested file piece from a client machine containing a copy of said file piece.

17. A system for distributing information in a computer network, the system comprising:
a dividing component which divides an electronic file into a plurality of pieces;
a first receiver which receives a request for a file piece from a first client machine;
a communications component which downloads the requested file piece to the first client machine;
a second receiver which receives a request for said file piece from a second client machine; and
a redirecting component which redirects the request of the second client machine to the first client machine.

18. A system for distributing information in a computer network, the system comprising:
a first communications component which requests one of a plurality of pieces of an electronic file, wherein the electronic file is stored in a server;
a first receiver which receives the requested file piece from the server;
a second receiver which receives a request for said file piece from a client machine, wherein the request is redirected from the server; and
a second communications component which sends said file piece to said client machine.

19. A system for obtaining distributed information in a computer network, the system comprising:
a communications component requesting one of a plurality of pieces of an electronic file, wherein the electronic file is stored in a server;
a receiver which receives the requested file piece from a client machine containing a copy of said file piece.
